(19) United States
(12) Patent Application Publication
(10) Pub. No.: US 2006/0083180 A1
(43) Pub. Date: Apr. 20, 2006

(54) Packet analysis system

(75) Inventors: Shunsuke Baba, Tokyo (JP); Kazuya Suzuki, Tokyo (JP); Takashi Tanaka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/233,063

(22) Filed: Sep. 23, 2005

(30) Foreign Application Priority Data
Oct. 19, 2004 (JP) P. 2004-303857

(51) Int. Cl. G06F 15/173; H04J 1/16

(52) U.S. Cl. 370/252; 709/223

(57) ABSTRACT

A packet analysis system captures packets propagating through a network, and analyzes the captured packets. The packet analysis has a plurality of terminal node type sensors and a server. Each of the terminal node type sensors captures packets propagating through the network, and classifies the captured packets. A server acquires classification information from at least one of the terminal node type sensors through the network, and generates a whole report of the packet analysis system based the acquired classification information.

### CROSS-REFERENCE TO RELATED APPLICATIONS

This application is based upon and claims the benefit of priority from the prior Japanese Patent Applications No. 2004-303857, filed on Oct. 19, 2004, the entire contents of which are incorporated herein by reference.

### BACKGROUND OF THE INVENTION

1. Field of the Invention

This invention relates to a packet analysis system for capturing packets propagating through a network such as the Internet and analyzing the captured packets, and in particular relates to a packet analysis system that can separate an access variation hard to separate.

2. Description of the Related Art

JP-A-2002-185539, JP-A-2003-204358 and JP-A-2003-273936 are referred to as related art relevant to a packet analysis system for capturing packets propagating through a network such as the Internet and analyzing the captured packets.

FIG. 24 is a block diagram to show a configuration example of such a packet analysis system in a related art. In FIG. 24, numeral 1 denotes a server for managing the whole packet analysis system, numerals 2, 3, and 4 denote firewalls installed between an internal network and an external network for the purpose of preventing external unauthorized access, numerals 5 and 6 denote computers connected to the internal network, numeral 100 denotes an external network such as the Internet, and numeral 101 denotes an internal network such as an intranet.

The server 1 is connected to the network 100, and connection ends of the firewalls 2, 3, and 4 for external network connection are connected to the network 100. The computers 5 and 6 are connected to connection ends of the firewalls 2 and 3 for internal network connection, and the network 101 is connected to a connection end of the firewall 4 for internal network connection.

The operation of the packet analysis system in the related art example shown in FIG. 24 will be discussed with reference to FIGS. 25, 26, 27, and 28. FIG. 25 is a flowchart to describe the operation of the server 1 for managing the whole packet analysis system, FIGS. 26 and 27 are schematic representations to describe an information flow of a packet, etc., and FIGS. 28A and 28B are schematic representation to show examples of the format and an analysis report of log information of a packet acquired in a firewall.

In FIG. 25, the server 1 determines whether or not it is to analyze a packet log at S001. If the server 1 determines that it is to analyze a packet log, the server 1 collects log information of stored packets from the firewalls 2 to 4 through the network 100 at S002 in FIG. 25.

For example, the server 1 collects the packet log information from the firewall 2 through the network 100 as indicated in CD01 in FIG. 26, and collects the packet log information from the firewalls 3 and 4 through the network 100 as indicated in CD02 and CD03 in FIG. 26.

The server 1 analyzes the collected packet log information at S003 in FIG. 25 and creates the analysis result as a report at S004 in FIG. 25 and transmits the report to the computer, etc.

For example, the server 1 creates the analysis result as a report and transmits the report to the computer 5 as indicated in RP11 in FIG. 27.

As an analysis method of the collected packet log information, the statistics for each time period are gathered based on the packet log information in a firewall having information as indicated in FW21 in FIG. 28A, whereby what packets have been propagated is determined.

Specifically, the total number of packets for each destination port for each time period is found, whereby a report as indicated in RP21 in FIG. 28B can be obtained. For example, information such that the number of packets flown to TCP/135 (port number 135 based on TCP (Transmission Control Protocol)) during the time period of 00:00 to 00:59 on 8/10 as indicated in TR21 in FIG. 28B is 2125 can be provided.

Consequently, firewalls are installed between the internal network and the external network and the server for managing the whole packet analysis system collects and analyzes the packet log information stored in each firewall, whereby it is made possible to analyze packets propagating through the network.

Packets propagating through the network may be analyzed based on log information not only in the firewalls, but also in an intrusion detection system (IDS).

FIGS. 29A and 29B are schematic representation to show examples of the format and an analysis report of log information of a packet acquired in the IDS.

As an analysis method of the collected packet log information, the statistics for each time period are gathered based on the packet log information in the IDS having information as indicated in ID31 in FIG. 29A, whereby what packets have been propagated is determined.

Specifically, the total number of packets for each IDS event for each time period is found, whereby a report as indicated in RP31 in FIG. 29B can be obtained. For example, information such that the number of packets which attempted to access TCP/135 (port number 135 based on TCP) during the time period of 00:00 to 00:59 on 8/10 as indicated in TR31 in FIG. 29B is 1125 can be provided.

Further, FIG. 30 is a schematic representation to show another example of an analysis report. The total number of packets for each protocol/port number is found from a packet dump, whereby a report as indicated in RP41 in FIG. 30 can be obtained. For example, information such that the number of packets flown to UDP/1434 (port number 1434 based on UDP (User Datagram Protocol) during the time period of 00:00 to 00:59 on 8/10 as indicated in TR41 in FIG. 30 is 1885 can be provided.

However, in the related art example shown in FIG. 24, the statistics for each packet or for each IDS event can be gathered, but association between packets and packet transmitter intentions are not classified.

Thus, to determine whether one packet is based on “worm (program which grows without infecting another program) A” or “worm B” or whether or not one packet is port scan, it is important to know the association between the packets; in the packet analysis system in the related art, however, the association between the packets is hard to know and if a subspecies of a worm occurs and mixes with a conventional worm, it is difficult to separate the subspecies; this is a problem.

For example, access to TCP/445 (port number 445 based on TCP) involves the following variations, which are difficult to separate although they are different worms:
(1) The presence of the server is confirmed with ICMP (Internet Control Message Protocol) Echo Request before TCP/445 is accessed.
(2) Only TCP/445 is accessed.
(3) The network is scanned for searching for TCP/445 service.
(4) TCP/139 is accessed before TCP/445 is accessed.
(5) Access in a combination of TCP/2745, TCP/135, TCP/1025, TCP/445, TCP/3127, TCP6129, TCP139, TCP/80.

### SUMMARY OF THE INVENTION

An object of the invention is to provide a packet analysis system that can separate an access variation hard to separate.

The invention provides a packet analysis system for capturing packets propagating through a network and analyzing the captured packets, the packet analysis system having: a plurality of terminal node type sensors which capture packets propagating through the network, and classify the captured packets; and a server which acquires classification information from at least one of the terminal node type sensors through the network, and generates a whole report of the packet analysis system based the acquired classification information.

In the packet analysis system, each of the terminal node type sensors has: a communication section which captures packets propagating through the network; an operation control section which classifies packets captured by the communication section in association with each other, and generates classification information; and a storage section which stores the packets captured by the communication section and the classification information generated by the operation control section.

In the packet analysis system, the terminal node type sensor classifies the captured packets according to destination port or type.

In the packet analysis system, the operation control section reads packets from the storage section, and classifies the captured packets according to destination port or type.

In the packet analysis system, the operation control section checks a source IP address of the captured packet, if an object corresponding to the same source IP address does not exist, the operation control section starts an object for storing an information list of packet information class instances and finally generating classification information, and generates packet information in a packet information instance list, and records a time of the generation thereof, whereas if the object corresponding to the same source IP address exists, the operation control section adds packet information to a packet information instance list, and records a time of the addition thereof, and wherein the operation control section determines an existence condition of the object every regular inspection time, and if the existence condition is not satisfied, packet information stored in the packet information instance list is output together with the source IP addresses to generate classification information.

In the packet analysis system, if addition of packet information to the packet information instance list is not executed for a given time, the operation control section determines that the existence condition is not satisfied.

In the packet analysis system, the given time is variable.

In the packet analysis system, the terminal node type sensor classifies the captured packet according to a difference of packet propagation method.

In the packet analysis system, the operation control section classifies the captured packet according to a difference of packet propagation method.

In the packet analysis system, if the number of types of source port numbers and the number of types of destination port numbers are equal and the number of types of destination network addresses and the number of types of destination host addresses are equal, the operation control section classifies the acquired packet into type “Normal.”

In the packet analysis system, if the number of types of source port numbers is larger than the number of types of destination port numbers and the number of types of destination network addresses and the number of types of destination host addresses are equal, the operation control section classifies the acquired packet into type “Port_Scan.”

In the packet analysis system, if the number of types of source port numbers is smaller than the number of types of destination port numbers and the number of types of destination network addresses and the number of types of destination host addresses are equal, the operation control section classifies the acquired packet into type “Port_Scan2.”

In the packet analysis system, if the number of types of source port numbers is larger than the number of types of destination port numbers and the number of types of destination network addresses is smaller than the number of types of destination host addresses, the operation control section classifies the acquired packet into type “Network_Scan.”

In the packet analysis system, if the number of types of source port numbers and the number of types of destination port numbers are equal and the number of types of destination network addresses is smaller than the number of types of destination host addresses, the operation control section classifies the acquired packet into type “Network_Scan2.”

In the packet analysis system, if the number of types of source port numbers is smaller than the number of types of destination port numbers and the number of types of destination network addresses is smaller than the number of types of destination host addresses, the operation control section classifies the acquired packet into type “Network_Scan3.”

In the packet analysis system, the server acquires classification information from each of the terminal node type sensors through the network, and integrates the acquired classification information to create the report.

In the packet analysis system, the server acquires retained classification information from one of the terminal node type sensors through the network, and integrates the acquired classification information to create the report.

In the packet analysis system, the server acquires retained classification information from any terminal node type sensor selected from among the terminal node type sensors through the network, and integrates the acquired classification information to create the report.

In the packet analysis system, the report involves information regarding date, time, milliseconds, source IP address, country code, protocol, classification based on packet propagation method difference, and classification based on packet destination port or type.

In the packet analysis system, the report is a log file.

According to the invention according to the packet analysis system, since the terminal node type sensors capture packets propagating through the network and classify the packets for each port (or for each type) and classify the packets according to the propagation method difference, it is made possible to separate an access variation hard to separate.

Further, since the server integrates the classification information provided by each terminal node type sensor to create the whole report (log file), it is made possible to separate an access variation hard to separate.

### BRIEF DESCRIPTION OF THE DRAWINGS

FIG. 1 is a block diagram to show the configuration of an embodiment of a packet analysis system according to the invention;

FIG. 2 is a block diagram to show the configuration of a specific example of a terminal node type sensor;

FIG. 3 is a flowchart to describe the operation of the terminal node type sensor;

FIG. 4 is a schematic representation to describe an information flow of a packet, etc.;

FIG. 5 is a schematic representation to describe an information flow of a packet, etc.;

FIG. 6 is a flowchart to describe the operation of the terminal node type sensor;

FIGS. 7A and 7B are schematic representation to describe classification methods according to a combination of destination ports;

FIG. 8 is a table to show an example of captured raw packet logs;

FIG. 9 is a table to show an example of classification information according to a combination of destination ports;

FIG. 10 is a table to describe definition of types classified according to the packet propagation method difference;

FIGS. 11A and 11B are tables to describe parameters and determination conditions of classification method based on the packet propagation method difference;

FIG. 12 is a table to show an example of classification information according to the packet propagation method difference;

FIG. 13 is a flowchart to describe the operation of a server;

FIG. 14 is a schematic representation to describe an information flow;

FIGS. 15A and 15B are schematic representation to describe the format, etc., of a whole report (log file);

FIG. 16 is a schematic representation to show a specific example of a whole report (log file);

FIG. 17 is a schematic representation to describe variations that can be separated;

FIG. 18 is a schematic representation to show access progression to TCP/445;

FIG. 19 is a schematic representation to show progression of ICMP Echo Request;

FIG. 20 is a schematic representation to show progression of access only to TCP/445 after ICMP Echo Request;

FIG. 21 is a schematic representation to show progression of access only to a set of TCP/135 and TCP/445;

FIG. 22 is a schematic representation to show progression of access only to a set of TCP/135, TCP/445, and TCP/1025;

FIG. 23 is a schematic representation to show progression of access only to a set of TCP/2745, TCP/135, TCP/1025, TCP/445, TCP/3127, TCP/6192, TCP/139, and TCP/80;

FIG. 24 is a block diagram to show a configuration example of a packet analysis system in a related art;

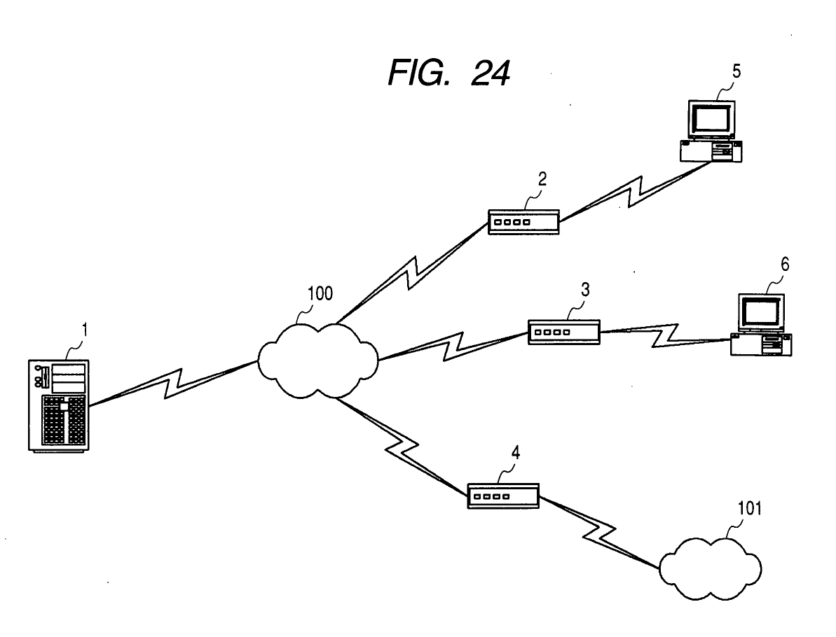

FIG. 25 is a flowchart to describe the operation of a server for managing the whole packet analysis system;

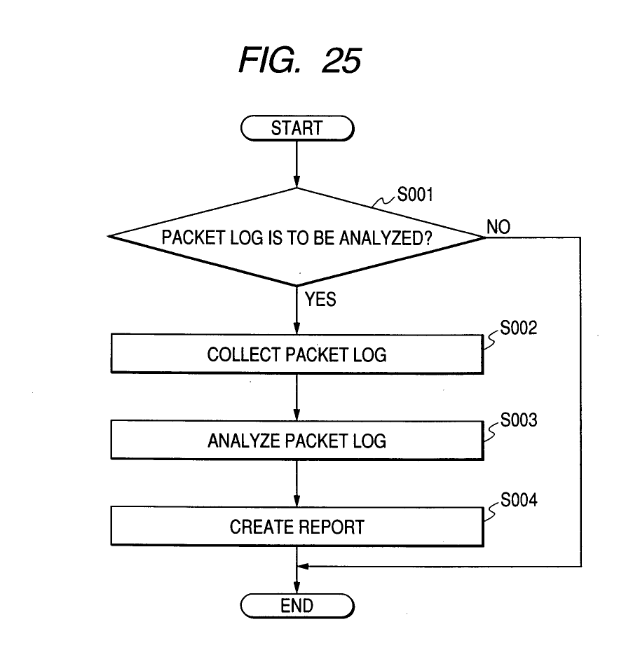

FIG. 26 is a schematic representation to describe an information flow of a packet, etc.;

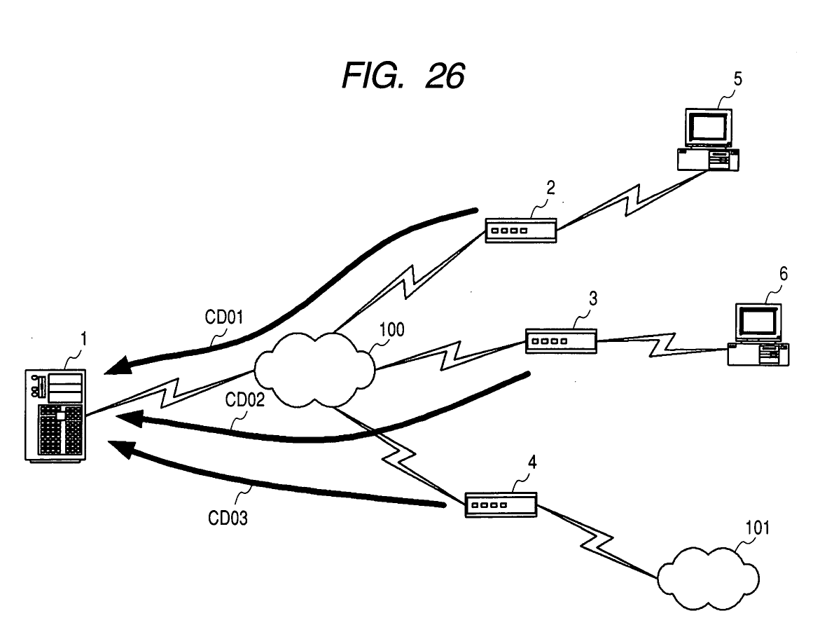

FIG. 27 is a schematic representation to describe an information flow of a packet, etc.;

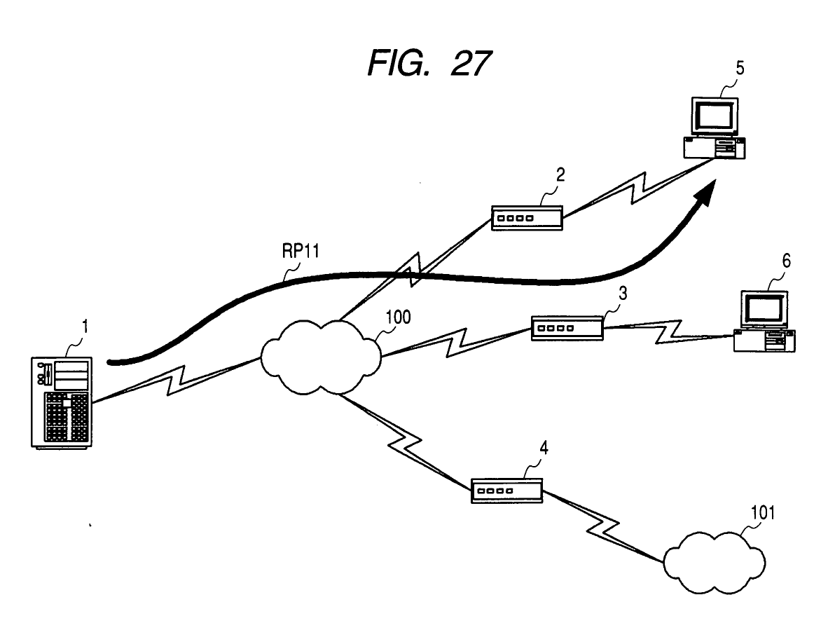

FIGS. 28A and 28B are schematic representation to show examples of the format and an analysis report of log information of a packet acquired in a firewall;

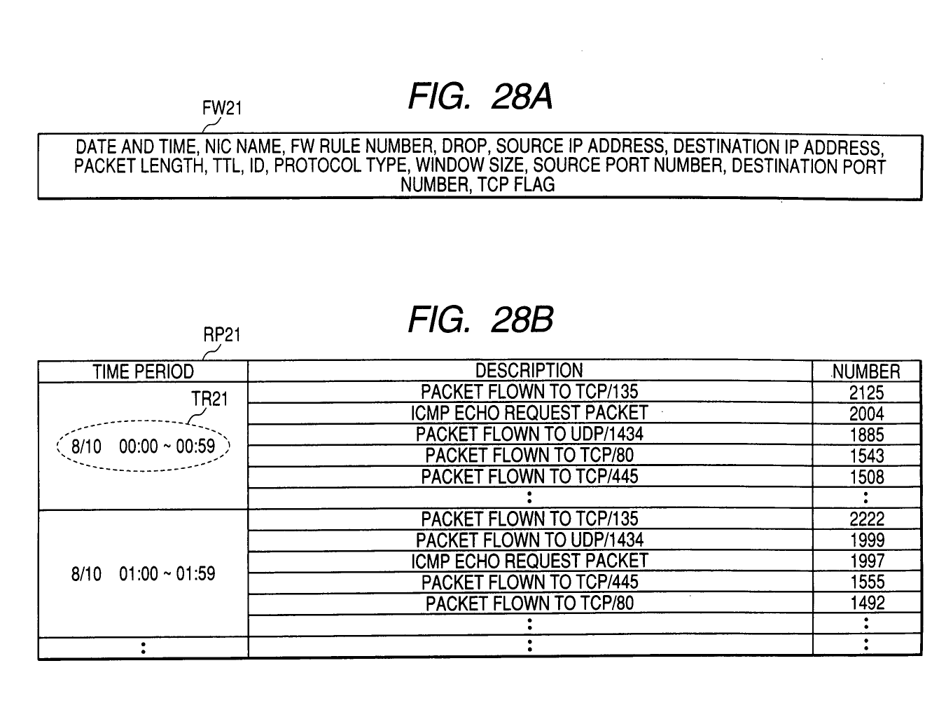

FIGS. 29A and 29B are schematic representation to show examples of the format and an analysis report of log information of a packet acquired in an IDS; and

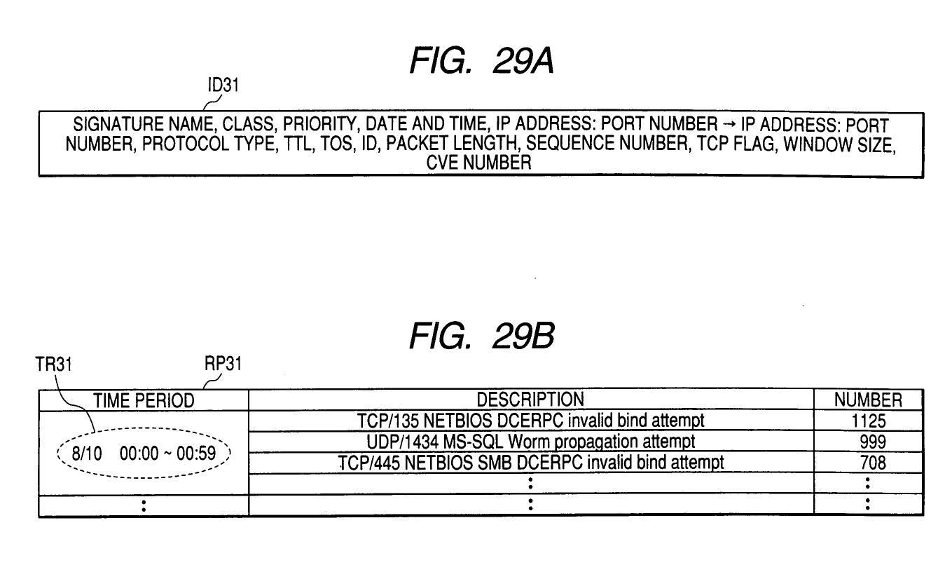

FIG. 30 is a schematic representation to show another example of an analysis report.

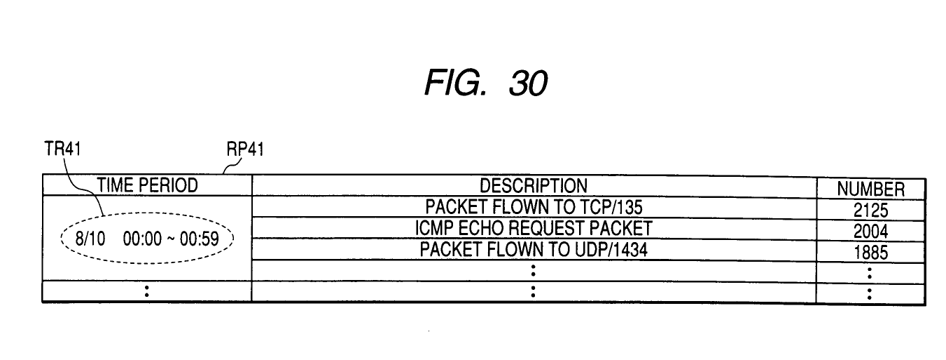

### DETAILED DESCRIPTION OF THE PREFERRED EMBODIMENTS

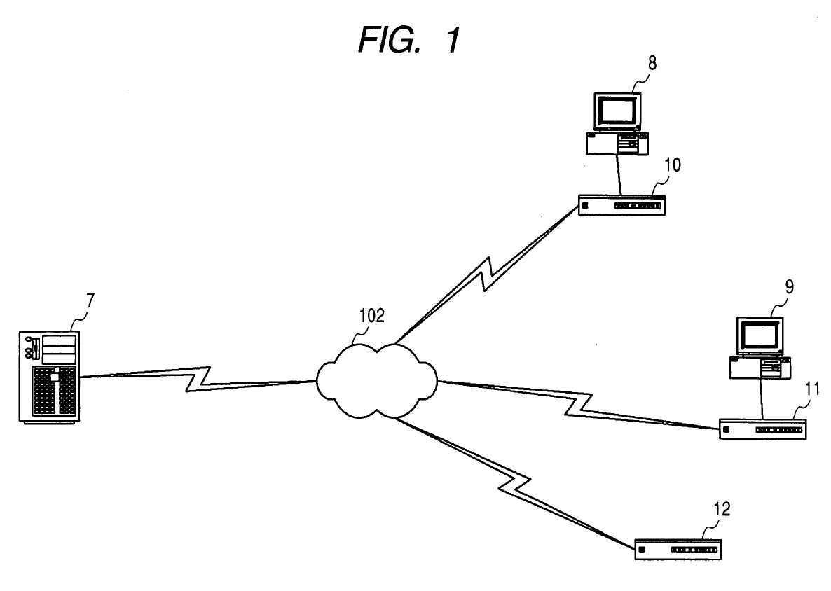

An embodiment of the invention will be discussed in detail with the accompanying drawings. FIG. 1 is a block diagram to show the configuration of an embodiment of a packet analysis system according to the invention.

In FIG. 1, numeral 7 denotes a server which generates a whole report (a log file) of the packet analysis system, numerals 8 and 9 denote computers, numerals 10, 11, and 12 denote terminal node type sensors which are connected to the computers or installed solely at a plurality of locations, and capture propagating packets and classify the captured packets in association with each other, and numeral 102 denotes a general-purpose network such as the Internet.

The server 7 is connected to the network 102, and the terminal node type sensors 10, 11, and 12 are also connected to the network 102. The computers 8 and 9 are connected to terminals of the terminal node type sensors 10 and 11.

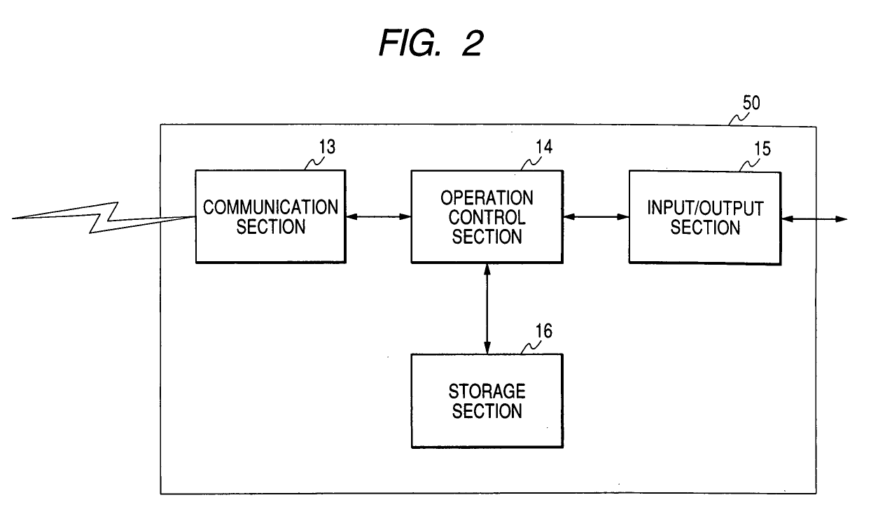

FIG. 2 is a block diagram to show the configuration of a specific example of the terminal node type sensor 10, 11, 12. In FIG. 2, numeral 13 denotes a communication section which captures packets propagating through the network 102, numeral 14 denotes an operation control section such as a CPU (Central Processing Unit), numeral 15 denotes an input/output section which transfers packets to and from an equipment such as a computer connected to a terminal, and numeral 16 denotes a storage section which stores a program for controlling the terminal node type sensor, the captured packets, classification information of the packets. The communication section 13, the operation control section 14, the input/output section 15, and the storage section 16 constitutes a terminal node type sensor 50.

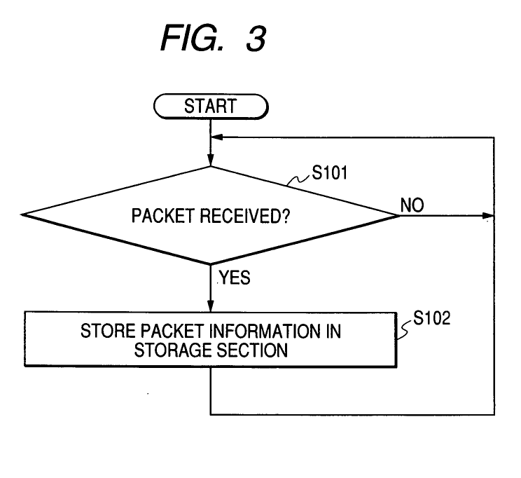

The operation of the embodiment of the packet analysis system shown in FIG. 1, particularly the operation of the terminal node type sensor shown in FIGS. 1 and 2, will be discussed with FIGS. 3 to 12.

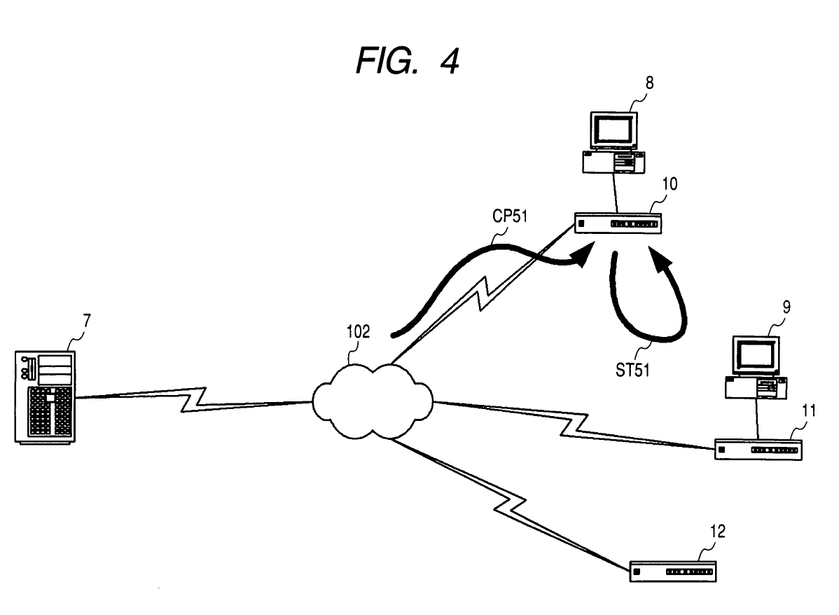

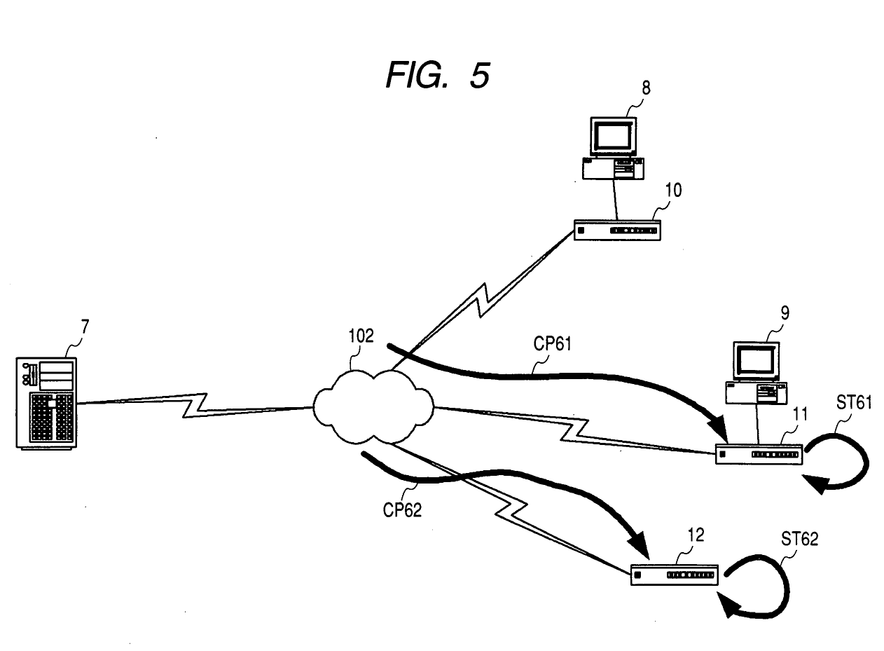

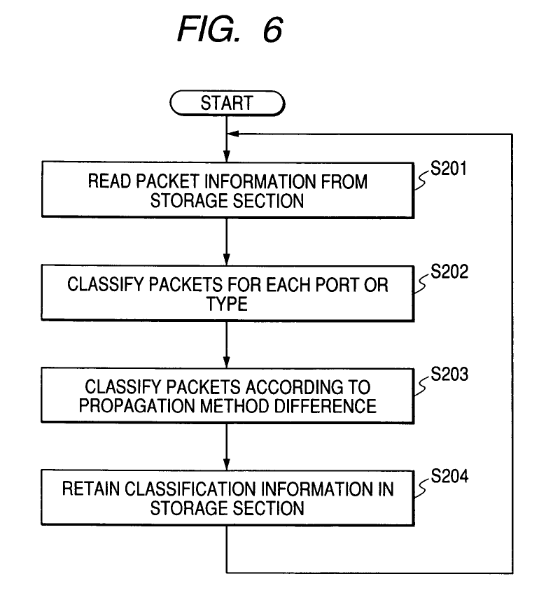

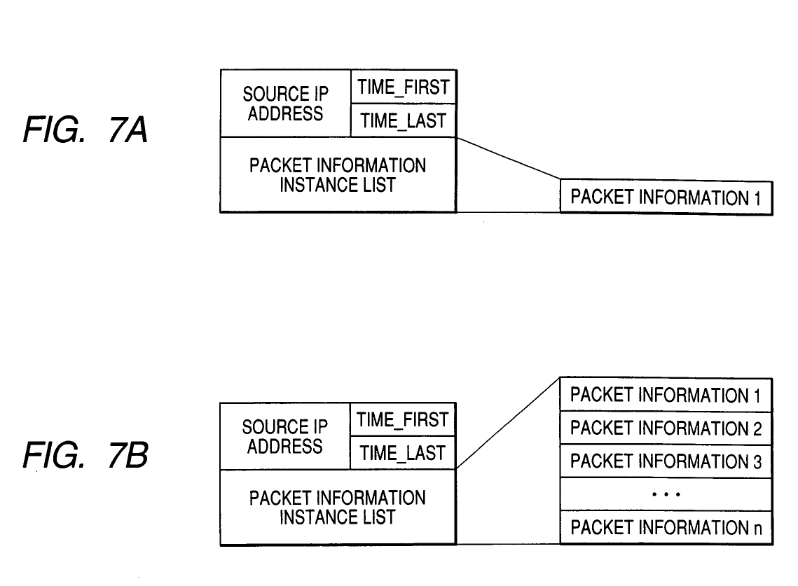

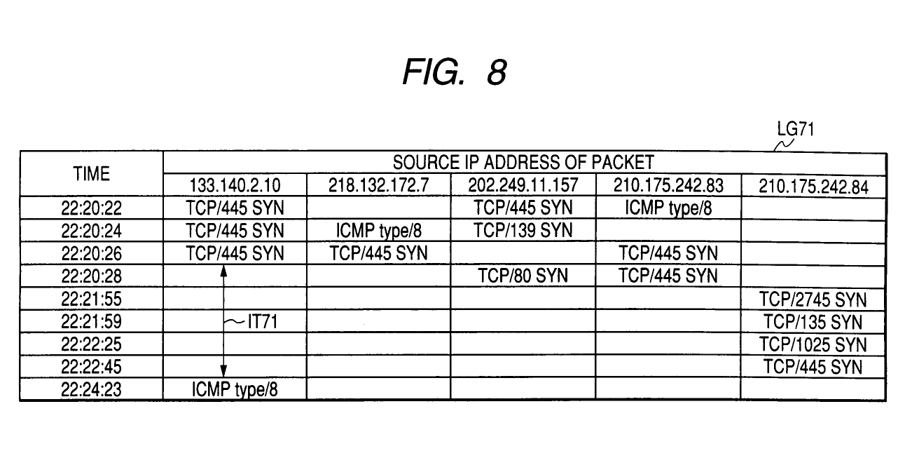

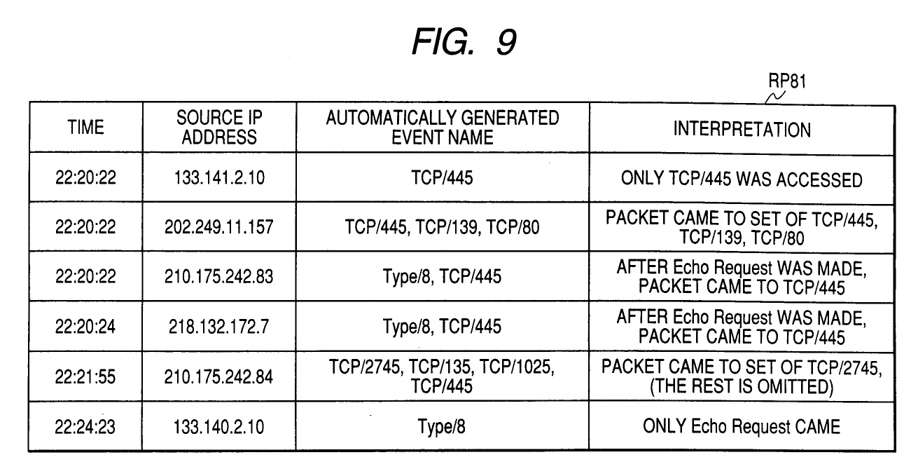

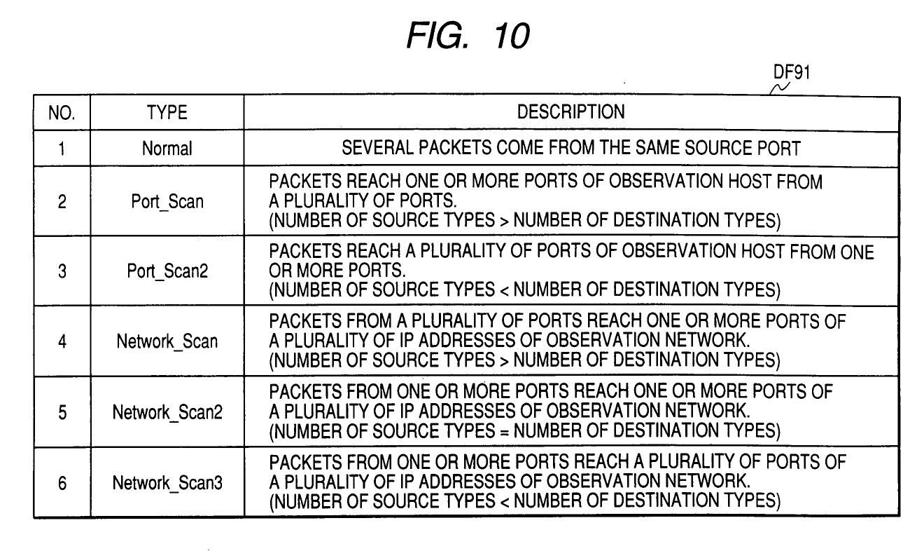

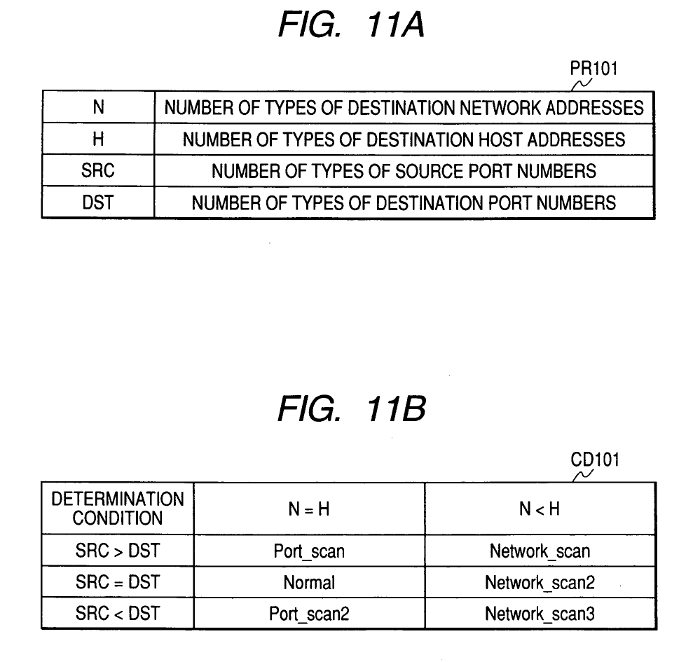

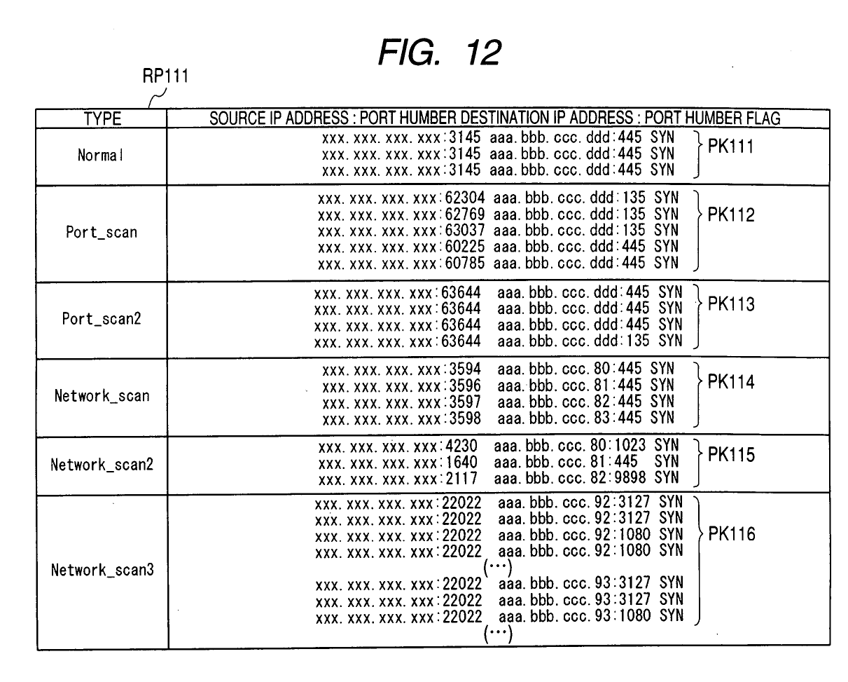

FIGS. 3 and 6 are flowcharts to describe the operation of the terminal node type sensor, FIGS. 4 and 5 are schematic representations to describe an information flow of a packet, etc., FIGS. 7A and 7B are schematic representation to describe classification methods according to a combination of destination ports (accurately, attention is focused on source IP address and destination port number in TCP and UDP; attention is focused on source IP address and ICMP type in ICMP), FIG. 8 is a table to show an example of captured raw packet logs, FIG. 9 is a table to show an example of classification information according to a combination of destination ports (accurately, attention is focused on source IP address and destination port number in TCP and UDP; attention is focused on source IP address and ICMP type in ICMP), FIG. 10 is a table to describe definition of types classified according to the packet propagation method difference, FIG. 11A and 11B are tables to describe parameters and determination conditions of classification method based on the packet propagation method difference, and FIG. 12 is a table to show an example of classification information according to the packet propagation method difference.

In FIG. 3, the terminal node type sensor, specifically the operation control section 14, determines whether or not a packet propagated through the network 102 is received (captured) by the communication section 13 in a stationary state at S101. If the terminal node type sensor, specifically the operation control section 14, determines that a packet is received (captured), it stores the received (captured) packet in the storage section 16 at S102 in FIG. 3. The operation control section 14 also transfers the received (captured) packet to a machine at the following stage through the input/output section 15 as required.

For example, upon reception (capture) of a packet which propagated through the network 102 through the communication section 13 as indicated in CP51 in FIG. 4, the terminal node type sensor 10 (specifically the operation control section 14) stores the received (captured) packet in the storage section 16 as indicated in ST51 in FIG. 4.

Likewise, for example, upon reception (capture) of a packet which propagated through the network 102 through the communication section 13 as indicated in CP61 and CP62 in FIG. 5, the terminal node type sensors 11 and 12 (specifically the operation control section 14) store the received (captured) packet in the storage section 16 as indicated in ST61 and ST62 in FIG. 5.

On the other hand, at S201 in FIG. 6, the terminal node type sensor, specifically the operation control section 14, reads the received (captured) packets from the storage section 16 and classifies the packets for each port or for each type at S202 in FIG. 6.

Specifically, in the operation control section 14, the source IP address of each received (captured) packet is checked and if the object corresponding to the same source IP address does not exist, as shown in FIG. 7A, an object for storing an information list of packet information class instances and finally generating classification information is started. At this time, PACKET INFORMATION 1 is generated in the packet information instance list and the time is recorded in TIME_FIRST.

The operation control section 14 checks the source IP address of each received (captured) packet in sequence. If the object corresponding to the same source IP address exists, PACKET INFORMATION 2, etc., is added to the packet information instance list in sequence and the addition time is recorded in TIME_LAST, as shown in FIG. 7B.

Last, the existence condition of the object is determined every regular inspection time. If the existence condition is not satisfied, PACKET INFORMATION 1 to PACKET INFORMATION n stored in the packet information instance list are output together with the source IP addresses and classification information is generated.

As the existence condition, if the inspection interval is set to L=10 seconds, “the difference between the inspection time and TIME_LAST is less than N=30 seconds” and “the difference between the inspection time and TIME_FIRST is less than M=60 seconds.”

For example, received (captured) raw packet logs as indicated in LG71 in FIG. 8 are classified according to the method described above, whereby information as indicated in RP81 in FIG. 9 is provided. That is, packets are classified for each accessed port number or for each type for each source IP address and are listed in time sequence in the access order under the column of automatically generated event name.

At S203 in FIG. 6, the terminal node type sensor, specifically the operation control section 14, classifies the received (captured) packets according to the received (captured) packet propagation method difference. At S204 in FIG. 6, the terminal node type sensor, specifically the operation control section 14, retains classification information in the storage section 16.

For example, the received (captured) packets are classified into six types of “Normal,” “Port_Scan,” “Port_Scan2,” “Network_Scan,” “Network_Scan2,” and “Network_Scan3” according to the received (captured) packet propagation method difference, as indicated in DF91 in FIG. 10.

PR101 in FIG. 11A indicates parameters at classification time, and CD101 in FIG. 11B indicates determination conditions.

Specifically, the classification information provided according to the received (captured) packet propagation method difference becomes as in RP111 in FIG. 12.

For example, PK111 in FIG. 12 is classified into type “Normal” from the determination conditions in CD101 in FIG. 11B because the number of types of source port numbers (one: Port number 3145) and the number of types of destination port numbers (one: Port number 445) are equal (SRC=DST) and the number of types of destination network addresses (one: aaa.bbb.ccc) and the number of types of destination host addresses (one: aaa.bbb.ccc.ddd) are equal (N=H).

Likewise, for example, PK112 in FIG. 12 is classified into type “Port_Scan” from the determination conditions in CD101 in FIG. 11B because the number of types of source port numbers (five: Port numbers 62304, 62769, 63037, 60225, and 60785) is larger than the number of types of destination port numbers (two: Port numbers 135 and 445) (SRC>DST) and the number of types of destination network addresses (one: aaa.bbb.ccc) and the number of types of destination host addresses (one: aaa.bbb.ccc.ddd) are equal (N=H).

Likewise, for example, PK113 in FIG. 12 is classified into type “Port_Scan2” from the determination conditions in CD101 in FIG. 11B because the number of types of source port numbers (one: Port number 63644) is smaller than the number of types of destination port numbers (two: Port numbers 135 and 445) (SRC<DST) and the number of types of destination network addresses (one: aaa.bbb.ccc) and the number of types of destination host addresses (one: aaa.bbb.ccc.ddd) are equal (N=H).

Likewise, for example, PK114 in FIG. 12 is classified into type “Network_Scan” from the determination conditions in CD101 in FIG. 11B because the number of types of source port numbers (four: Port numbers 3594, 3596, 3597, and 3598) is larger than the number of types of destination port numbers (one: Port number 445) (SRC>DST) and the number of types of destination network addresses (one: aaa.bbb.ccc) is smaller than the number of types of destination host addresses (four: aaa.bbb.ccc.80 to aaa.bbb.ccc.83) (N<H).

Likewise, for example, PK115 in FIG. 12 is classified into type “Network_Scan2” from the determination conditions in CD101 in FIG. 11B because the number of types of source port numbers (three: Port numbers 4230, 1640, and 2117) and the number of types of destination port numbers (three: Port numbers 1023, 445, and 9898) are equal (SRC=DST) and the number of types of destination network addresses (one: aaa.bbb.ccc) is smaller than the number of types of destination host addresses (three: aaa.bbb.ccc.80 to aaa.bbb.ccc.82) (N<H).

Likewise, for example, PK116 in FIG. 12 is classified into type “Network_Scan3” from the determination conditions in CD101 in FIG. 11B because the number of types of source port numbers (one: Port number 22022) is smaller than the number of types of destination port numbers (two: Port numbers 3127 and 1080) (SRC<DST) and the number of types of destination network addresses (one: aaa.bbb.ccc) is smaller than the number of types of destination host addresses (two: aaa.bbb.ccc.91 and aaa.bbb.ccc.93) (N<H).

Consequently, each of the terminal node type sensors connected to the computers or installed solely at a plurality of locations captures packets propagating through the network and classifies the captured packets for each port (or for each type) and classifies the packets according to the propagation method difference, whereby it is made possible to associate the packets with each other, classifies the packets, and analyzes the packets, and it is made possible to separate an access variation hard to separate.

To capture the packets propagating through the network and classify the captured packets for each port (or for each type), classification processing is performed in a pipeline method by the object, so that the packet analysis system has a high real-time property.

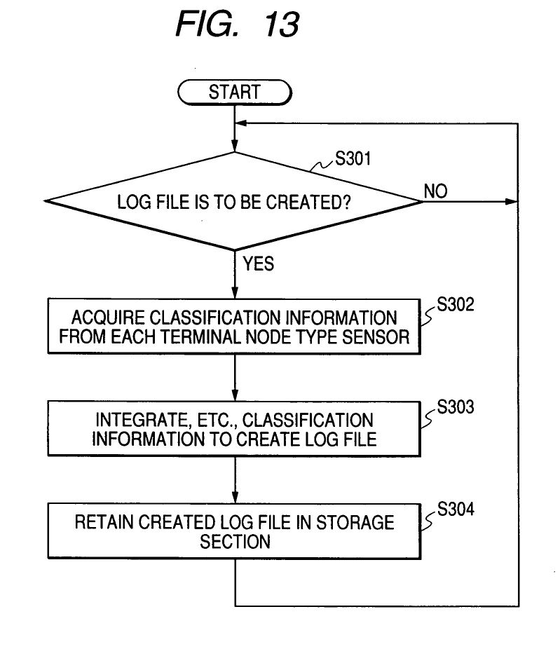

The operation of the embodiment of the packet analysis system shown in FIG. 1, particularly the operation of the server 7 will be discussed with FIGS. 13 to 23.

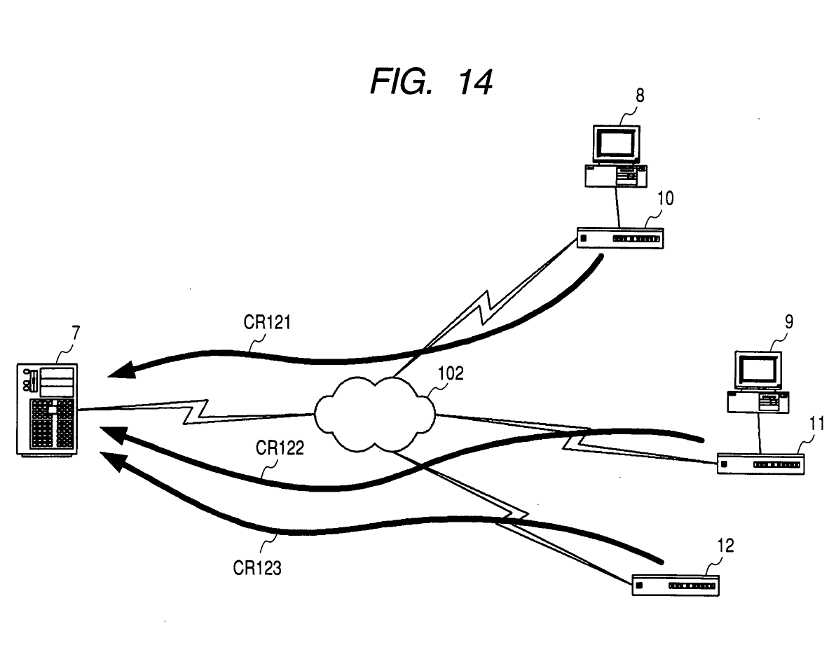

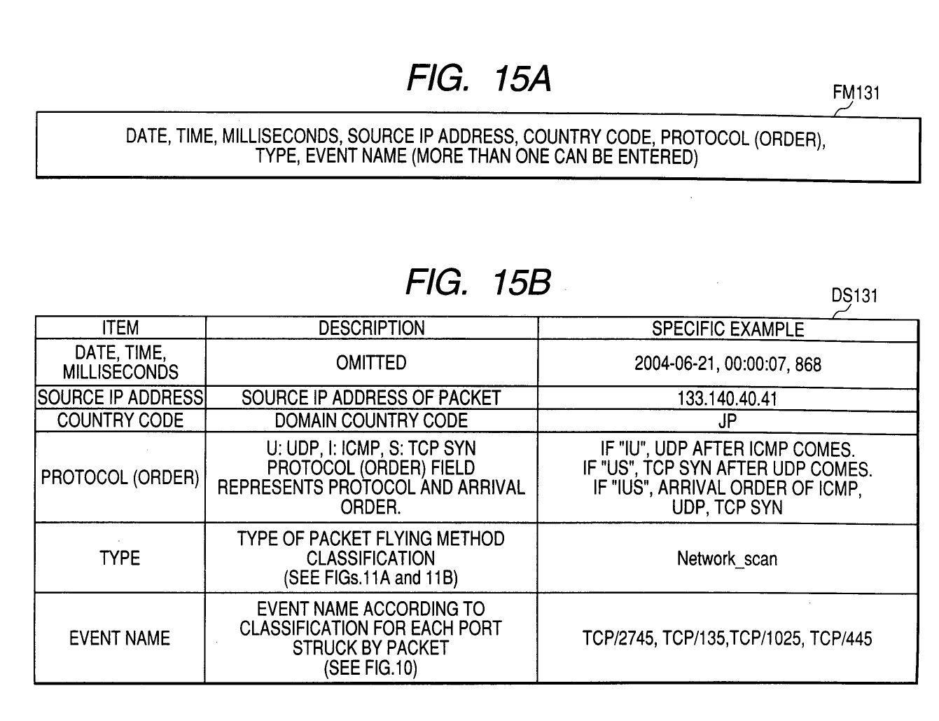

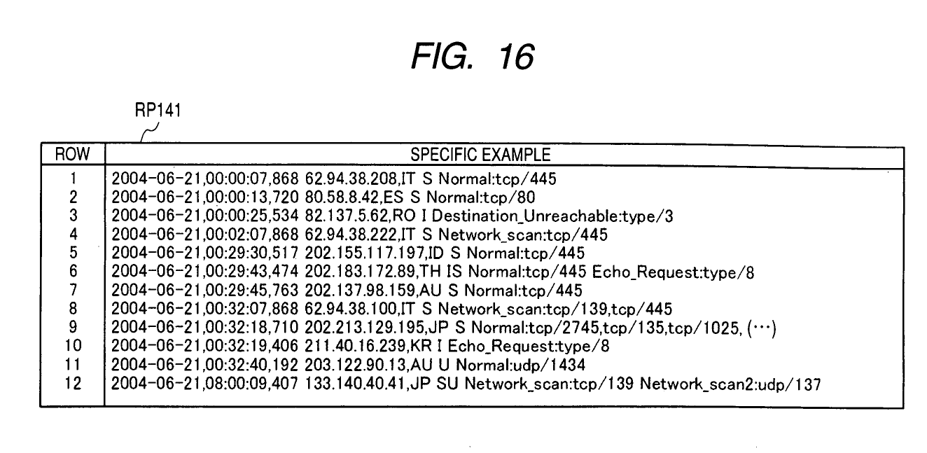

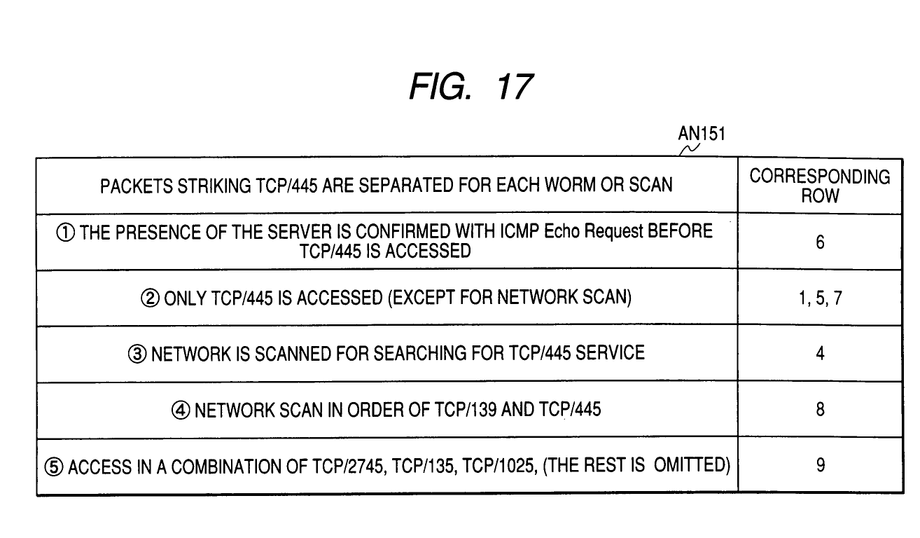

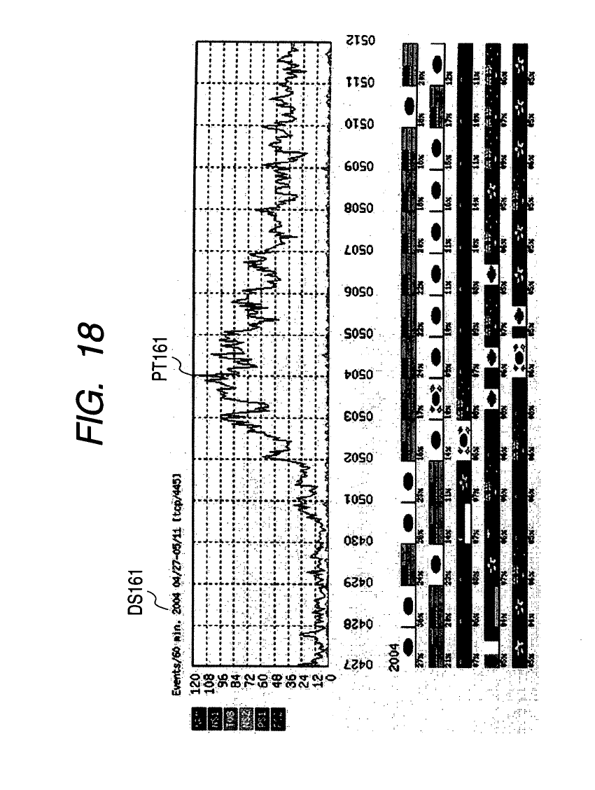

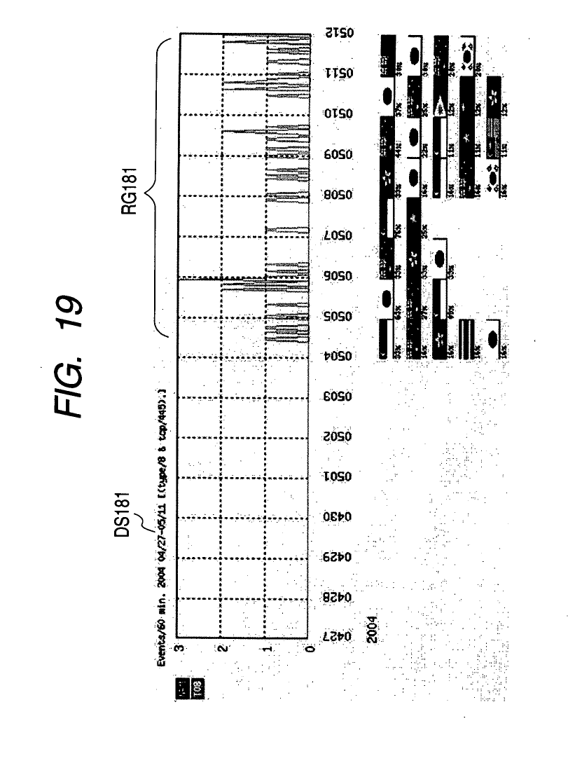

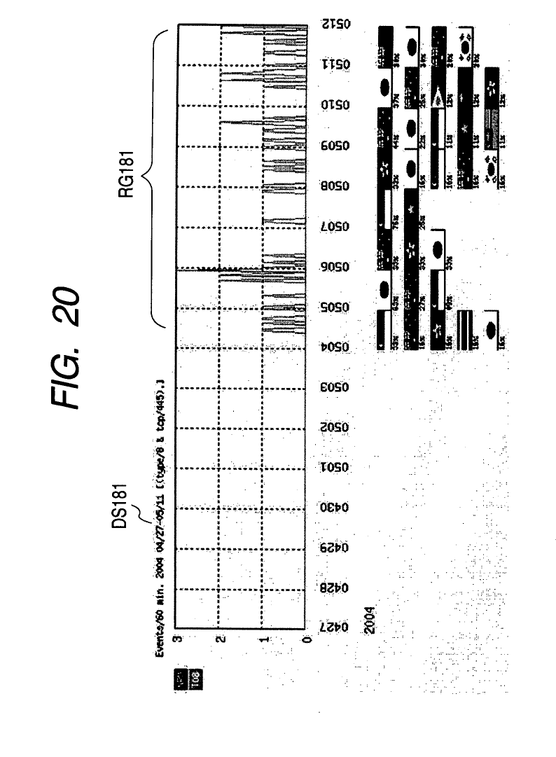

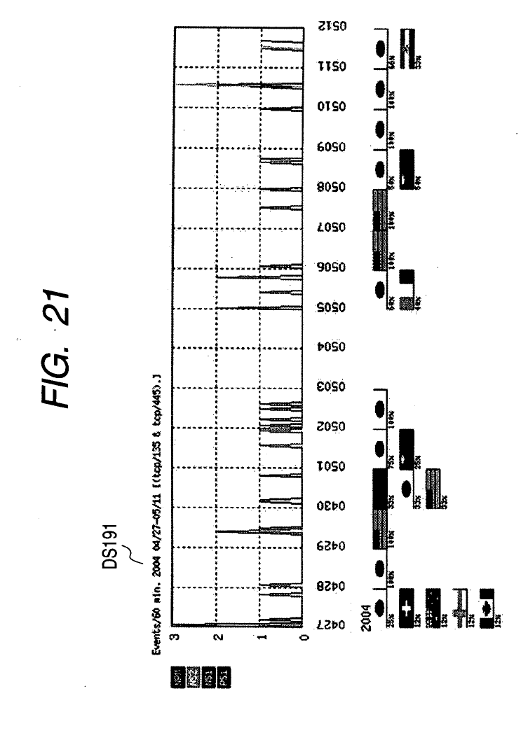

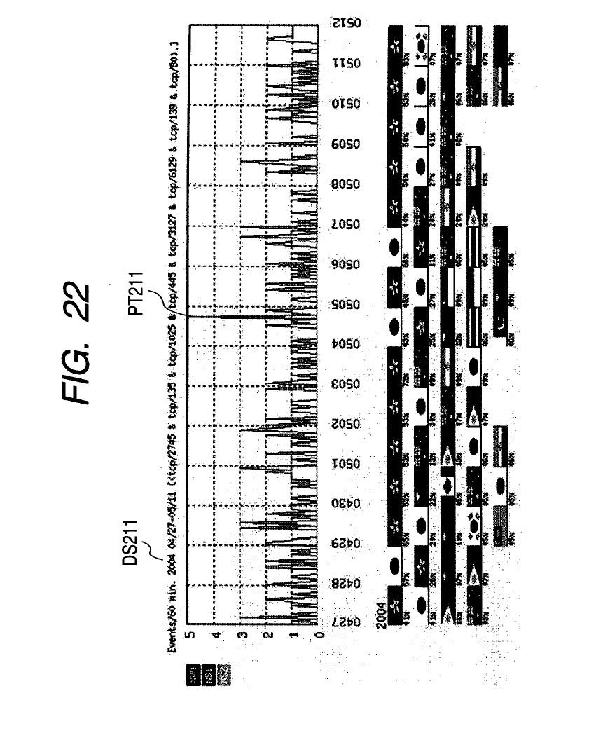

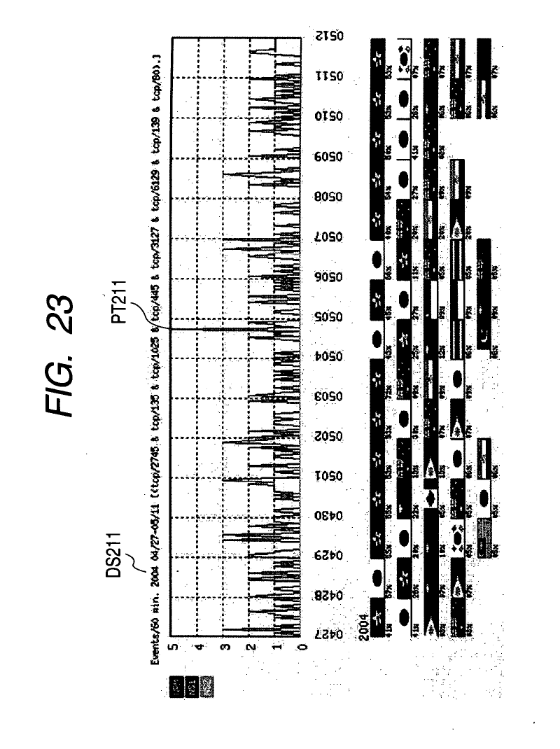

FIG. 13 is a flowchart to describe the operation of the server 7, FIG. 14 is a schematic representation to describe an information flow, FIGS. 15A and 15B are schematic representation to describe the format, etc., of a whole report (log file), FIG. 16 is a schematic representation to show a specific example of a whole report (log file), FIG. 17 is a schematic representation to describe variations that can be separated, FIG. 18 is a schematic representation to show access progression to TCP/445, FIG. 19 is a schematic representation to show progression of ICMP Echo Request, FIG. 20 is a schematic representation to show progression of access only to TCP/445 after ICMP Echo Request, FIG. 21 is a schematic representation to show progression of access only to a set of TCP/135 and TCP/445, FIG. 22 is a schematic representation to show progression of access only to a set of TCP/135, TCP/445, and TCP/1025, and FIG. 23 is a schematic representation to show progression of access only to a set of TCP/2745, TCP/135, TCP/1025, TCP/445, TCP/3127, TCP/6192, TCP/139, and TCP/80.

At S301 in FIG. 13, the server 7 determines whether or not it is to generate a whole report (log file). If the server 7 determines that it is to generate a whole report (log file), the server 7 acquires retained classification information (classification for each port (or for each type) and classification according to the propagation method difference) from each terminal node type sensor through the network 102 at S302 in FIG. 13.

For example, the retained classification information (classification for each port (or for each type) and classification according to the propagation method difference) is collected from the terminal node type sensors 10, 11, and 12 as indicated in CR121, CR122, and CR123 in FIG. 14.

At S303 in FIG. 13, the server 7 integrates, etc., the classification information acquired from each terminal node type sensor to create a whole report (log file), and retains the created whole report (log file) in the storage section (not shown) at S304 in FIG. 13.

For example, as the format of the whole report (log file), “date,” “time,” “milliseconds,” “source IP address,” “country code,” “protocol (order),” “type,” and “event name” are described in order as indicated in FM131 in FIG. 15A.

More specifically, “2004-06-21, 00:00:07, 868” is described as “date,” “time,” and “milliseconds,” “133.140.40.41” is described as “source IP address,” “JP” is described as “country code,” “IU,” “US,” or “IUS” is described as “protocol (order),” “Network_Scan” is described as “type,” and “TCP/2745, TCP/135, TCP1025, TCP445,” etc., is described as “event name.”

Thus, a specific example of the whole report (log file) becomes as indicated in PR141 in FIG. 16.

In the specific example of the whole report (log file) as indicated in PR141 in FIG. 16, if “packets accessing TCP/445 are separated for each worm or scan,” it is made possible to separate access variations as indicated in AN151 in FIG. 17 as the problem in the related art example.

That is, “(1) The presence of the server is confirmed with ICMP (Internet Control Message Protocol) Echo Request before TCP/445 is accessed” corresponds to row 6 in PR141 in FIG. 16.

Likewise, “(2) Only TCP/445 is accessed” corresponds to row 1, row 5, row 7 in PR141 in FIG. 16.

Likewise, “(3) The network is scanned for searching for TCP/445 service” corresponds to row 4 in PR141 in FIG. 16.

Likewise, “(4) TCP139 is accessed before TCP/445 is accessed” corresponds to row 8 in PR141 in FIG. 16.

Likewise, “(5) Access in a combination of TCP/2745, TCP/135, TCP/1025, TCP/445, TCP/3127, TCP6129, TCP139, TCP/80” corresponds to row 9 in PR141 in FIG. 16.

Consequently, the server 7 integrates the classification information provided by each terminal node type sensor to create a whole report (log file), whereby it is made possible to separate access variations hard to separate conventionally.

Last, in the schematic representation to show access progression to TCP/445 indicated in DS161 in FIG. 18, the access peak is recognized at the time indicated in PT161 in FIG. 18, but all packets accessing TCP/445 are targets and thus it is difficult to separate access variations.

In the schematic representation to show progression of ICMP Echo Request indicated in DS171 in FIG. 19, frequent occurrence of ICMP Echo Request from the time indicated in PT171 in FIG. 19 is recognized, but it is difficult to separate access variations.

In contrast, in the schematic representation to show progression of access only to TCP/445 after ICMP Echo Request indicated in DS181 in FIG. 20, clearly packets accessing only TCP/445 after ICMP Echo Request concentrate on the time domain indicated in RG181 in FIG. 20.

Likewise, in the schematic representation to show progression of access only to a set of TCP/135 and TCP/445 indicated in DS191 in FIG. 21, packets accessing only to a set of TCP/135 and TCP/445 are recognized almost all over.

Likewise, in the schematic representation to show progression of access only to a set of TCP/135, TCP/445, and TCP/1025 indicated in DS201 in FIG. 22, clearly packets accessing only a set of TCP/135, TCP/445, and TCP/1025 concentrate on the time domain indicated in RG201 in FIG. 22.

Last, in the schematic representation to show progression of access only to a set of TCP/2745, TCP/135, TCP/1025, TCP/445, TCP/3127, TCP/6192, TCP/139, and TCP/80 indicated in DS211 in FIG. 23, the peak of packets accessing only a set of TCP/2745, TCP/135, TCP/1025, TCP/445, TCP/3127, TCP/6192, TCP/139, and TCP/80 is recognized at the time indicated in PT211 in FIG. 23 and access is recognized almost all over.

In the embodiment shown in FIG. 1, etc., for simplicity of the description, the existence condition is “the difference between the inspection time and TIME_LAST is less than N=30 seconds” and “the difference between the inspection time and TIME_FIRST is less than M=60 seconds” in classification for each port (or for each type), but the interval of the existence condition may be variable rather than fixed.

The server 7 integrates the classification information provided by each terminal node type sensor to create a whole report (log file). Of course, a report (log file) may be created for each terminal node type sensor or classification information provided by any selected terminal node type sensor may be integrated to create a report (log file)

In this case, not only a report (log file) of the whole package analysis system, but also a report (log file) created by integrating the classification information provided by each terminal node type sensor or any selected terminal node type sensor is provided, so that analysis in a partial area of the packet analysis system is facilitated.

In the embodiment shown in FIG. 1, etc., packets are classified according to the packet propagation method difference, so that it is made possible to separate packets even if a new type of attack or a new type of worm occurs. In other words, the packet analysis system can be used as an intrusion detection system of anomaly detection type.

In the embodiment shown in FIG. 1, etc., the terminal node type sensor for classifying packets for each port (or for each type) and classifying packets according to the propagation method difference at the same time is illustrated, but the terminal node type sensor may be a terminal node type sensor for classifying packets for each port (or for each type) or classifying packets according to the propagation method difference.

In the specific example shown in FIG. 2, the input/output section 15 for transferring a packet to and from a connected machine such as a computer is illustrated as one component of the terminal node type sensor. However, of course, if the terminal node type sensor is installed solely or is installed in parallel with a machine such as a computer, the input/output section 15 is not required and is not an indispensable component of the packet analysis system. The computer is not an indispensable component of the packet analysis system either.

What is claimed is:

1. A packet analysis system for capturing packets propagating through a network and analyzing the captured packets, the packet analysis system comprising:
a plurality of terminal node type sensors which capture packets propagating through the network, and classify the captured packets; and
a server which acquires classification information from at least one of the terminal node type sensors through the network, and generates a whole report of the packet analysis system based the acquired classification information.

2. The packet analysis system according to claim 1,
wherein each of the terminal node type sensors comprises:
a communication section which captures packets propagating through the network;
an operation control section which classifies packets captured by the communication section in association with each other, and generates classification information; and
a storage section which stores the packets captured by the communication section and the classification information generated by the operation control section.

3. The packet analysis system according to claim 1,
wherein the terminal node type sensor classifies the captured packets according to destination port or type.

4. The packet analysis system according to claim 2,
wherein the operation control section reads packets from the storage section, and classifies the captured packets according to destination port or type.

5. The packet analysis system according to claim 4,
wherein the operation control section checks a source IP address of the captured packet,
if an object corresponding to the same source IP address does not exist, the operation control section starts an object for storing an information list of packet information class instances and finally generating classification information, and generates packet information in a packet information instance list, and records a time of the generation thereof, whereas
if the object corresponding to the same source IP address exists, the operation control section adds packet information to a packet information instance list, and records a time of the addition thereof, and
wherein the operation control section determines an existence condition of the object every regular inspection time, and if the existence condition is not satisfied, packet information stored in the packet information instance list is output together with the source IP addresses to generate classification information.

6. The packet analysis system according to claim 5,
wherein if addition of packet information to the packet information instance list is not executed for a given time, the operation control section determines that the existence condition is not satisfied.

7. The packet analysis system according to claim 6,
wherein the given time is variable.

8. The packet analysis system according to claim 1,
wherein the terminal node type sensor classifies the captured packet according to a difference of packet propagation method.

9. The packet analysis system according to claim 2,
wherein the operation control section classifies the captured packet according to a difference of packet propagation method.

10. The packet analysis system according to claim 9,
wherein if the number of types of source port numbers and the number of types of destination port numbers are equal and the number of types of destination network addresses and the number of types of destination host addresses are equal, the operation control section classifies the acquired packet into type “Normal.”

11. The packet analysis system according to claim 9,
wherein if the number of types of source port numbers is larger than the number of types of destination port numbers and the number of types of destination network addresses and the number of types of destination host addresses are equal, the operation control section classifies the acquired packet into type “Port_Scan.”

12. The packet analysis system according to claim 9,
wherein if the number of types of source port numbers is smaller than the number of types of destination port numbers and the number of types of destination network addresses and the number of types of destination host addresses are equal, the operation control section classifies the acquired packet into type “Port_Scan2.”

13. The packet analysis system according to claim 9,
wherein if the number of types of source port numbers is larger than the number of types of destination port numbers and the number of types of destination network addresses is smaller than the number of types of destination host addresses, the operation control section classifies the acquired packet into type “Network_Scan.”

14. The packet analysis system according to claim 9,
wherein if the number of types of source port numbers and the number of types of destination port numbers are equal and the number of types of destination network addresses is smaller than the number of types of destination host addresses, the operation control section classifies the acquired packet into type “Network_Scan2.”

15. The packet analysis system according to claim 9,
wherein if the number of types of source port numbers is smaller than the number of types of destination port numbers and the number of types of destination network addresses is smaller than the number of types of destination host addresses, the operation control section classifies the acquired packet into type “Network_Scan3.”

16. The packet analysis system according to claim 1,
wherein the server acquires classification information from each of the terminal node type sensors through the network, and
integrates the acquired classification information to create the report.

17. The packet analysis system according to claim 1,
wherein the server acquires retained classification information from one of the terminal node type sensors through the network, and
integrates the acquired classification information to create the report.

18. The packet analysis system according to claim 1,
wherein the server acquires retained classification information from any terminal node type sensor selected from among the terminal node type sensors through the network, and
integrates the acquired classification information to create the report.

19. The packet analysis system according to claim 1,
wherein the report involves information regarding date, time, milliseconds, source IP address, country code, protocol, classification based on packet propagation method difference, and classification based on packet destination port or type.

20. The packet analysis system according to claim 1,
wherein the report is a log file.
